(19) United States
(12) Patent Application Publication
(10) Pub. No.: US 2026/0301731 A1
(43) Pub. Date: Oct. 1, 2026

(54) SYSTEMS AND METHODS FOR AI-DRIVEN CONTEXTUALIZED MULTI-CAST NARRATION

(71) Applicant: Philip Dana Marshall, Portland, OR (US)

(72) Inventor: Philip Dana Marshall, Portland, OR (US)

(21) Appl. No.: 19/632,121

(22) Filed: Mar. 27, 2026

Related U.S. Application Data
(60) Provisional application No. 63/780,094, filed on Mar. 28, 2025.

(51) Int. Cl. G10L 13/10; G06F 40/289; G06F 40/30; G10L 13/027; G10L 13/033

(52) U.S. Cl. CPC G10L 13/10; G06F 40/289; G06F 40/30; G10L 13/027; G10L 13/033

(57) ABSTRACT

Systems and methods are herein provided for an audio narration system. In one example, an audio narration system comprises a processor communicably coupled to non-transitory memory storing one or more AI models, the non-transitory memory including instructions that when executed cause the processor to: receive text data from a user input device; process the text data with the one or more AI models; generate an audio narration with the one or more AI models; and output the audio narration to the user input device.

### CROSS-REFERENCE TO RELATED APPLICATIONS

The present application claims priority to U.S. Provisional Application No. 63/780,094, entitled “SYSTEMS AND METHODS FOR AI-DRIVEN CONTEXTUALIZED MULTI-CAST NARRATION”, and filed on Mar. 28, 2025. The entire contents of the above-listed application are hereby incorporated by reference for all purposes.

### FIELD

Embodiments of the subject matter disclosed herein relate to audio narration, and more particularly to AI-driven contextualized multi-cast narration.

### BACKGROUND AND SUMMARY

Audio-based versions of written content have become increasingly popular among consumers. With increased accessibility of audio platforms (e.g., Spotify, Audible, Libby, and the like), more and more consumers are choosing to listen to audiobooks, screenplays, essays, and other types of works rather than reading text. Historically, self-publishing a written work has been difficult and monetarily costly. However, with advancement of platforms such as Kindle Direct Publishing and other self-publishing platforms, publishing written works has become more accessible to writers directly. Additionally, online-based platforms (e.g., Wattpad, Medium, Reddit, etc.) have provided accessible and cost-effective avenues for self-publishing shorter written works.

However, publishing audio versions of books, short stories, screenplays, essays, and the like remains expensive and difficult. In many circumstances, audio narration still demands someone read the text aloud in order to generate an audio version of the written text. Also, many text-to-speech applications with voice models may only present single-voice narration options that do not capture tone, context, speech inflections, and the like, thereby generating an unnatural speech output.

The inventors herein have recognized the aforementioned issues and developed systems and methods that at least partially address these issues. In one example, methods and system are herein disclosed for inputting text data, for example a story, chapter of a book, or the like, into one or more trained AI models for text analysis and audio narration generation. In one example, the system may be configured for unified text processing and speech generation in an iterative loop, wherein the one or more AI models. comprise a text analysis model and a separate narration model. In another example, the one or more AI models may comprise a single melded model trained on paired narrative data. In yet another example, a text analysis model may inject specific speech parameters directly into the narration model. In any of the aforementioned system examples, the system may be configured to analyze a sequence of passages to determine a plurality of parameters such as pacing, rhythm, genre, scene setting, and the like, as well as parsing the text into dialogue, narration, and meta-narration elements. The system may use these parameters to generate multi-cast audio narration of the inputted text.

In this way, via deployment of one or more trained AI models, text data may be analyzed in order to allow for context-specific multi-character audio narration. For example, the one or more models may classify passages of the text data as dialogue, narration, or meta-narration elements (e.g., internal thoughts, dream sequences, etc.), and may identify one or more context parameters both for each passage as well as for sequences of passages. These text classification and context parameters may be used to generate an audio narration for the text data that includes character-specific voice traits and intonations that correspond to scene, setting, and emotional context, and respects the narrative intent and sentence structure of the text data. In this way, the generated audio narration may be a more natural sounding output compared to traditional TTS outputs.

It should be understood that the brief description above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

The present disclosure will be better understood from reading the following description of non-limiting embodiments, with reference to the attached drawings, wherein below:

FIG. 1 shows a block diagram of an exemplary audio narration system, in accordance with one or more embodiments of the present disclosure;

FIG. 2 shows a block diagram of an exemplary text parsing large language model training system, in accordance with one or more embodiments of the present disclosure;

FIG. 3 shows a flowchart illustrating an exemplary method for training one or more models of the audio narration system, in accordance with one or more embodiments of the present disclosure;

FIG. 4 shows a flowchart illustrating a first example method for generating audio narration using the audio narration system of FIG. 1, in accordance with one or more embodiments of the present disclosure;

FIG. 5 shows a flowchart illustrating a second example method for generating audio narration using the audio narration system of FIG. 1, in accordance with one or more embodiments of the present disclosure;

FIG. 6 shows a flowchart illustrating a third example method for generating audio narration suing the audio narration system of FIG. 1, in accordance with one or more embodiments of the present disclosure; and

FIG. 7 shows a diagram of an exemplary neural network, in accordance with one or more embodiments of the present disclosure.

### DETAILED DESCRIPTION

The following description relates to various embodiments of an audio narration system. In particular, systems and methods for AI-driven contextualized multi-cast narration are herein disclosed. In one example, an audio narration system may comprise one or more AI models trained to analyze inputted text and generate an audio narration of the inputted text.

Traditional text-to-speech (TTS) models convert input text into audio (e.g., spoken) output in a linear manner. For example, TTS models may read text in a relatively static way, relying on punctuation for inflection and pausing. Further, TTS models may apply pre-set voices, thereby demanding human intervention to manually assign voices to different speakers. In addition, current TTS models do not differentiate between dialogue and narration, resulting in unnatural delivery whereby narrator tags, such as “he said” are spoken with the same intonation as character speech. Further, because TTS models analyze text as phonetic units on a line by line basis, they generate smooth, uninterrupted speech that does not express any emotional context, real human speech patterns (e.g., natural hesitations, sighs, breaths, and filler sounds), or adapt to evolving characterizations over the course of the text. These shortcomings of traditional TTS models thus result in an unnatural audio narration that does not replicate a human narrator.

In contrast, the audio narration system herein disclosed comprises text parsing and contextual analysis, narration performance dynamics, and synchronized AI narration. For example, one or more AI models may be included in the audio narration system that are configured to analyze and structure text, such as character-driven narrative texts, thus distinguishing dialogue from narration and identifying character attributes, narrative context, and other parameters. The system may assign attributes like tone, speed, emotion, pauses, and other non-verbal elements like breaths and hesitations to different passages according to the performed analysis, which may identify features of text passages indicative of the attributes. Based on the distinguished dialogue/narration passages, the character attributes, narrative context, and the like, as well as the narration attributes like tone and emotion, the system may generate an audio narration output. By analyzing the text to identify context parameters, character attributes and evolution, and the like, the system may generate a more natural audio narration.

In some examples, the audio narration that is generated may be a multi-cast narration, whereby each character is assigned to a distinct voice based on the identified character attributes. The delivery for each character, including the narrator, may be specific to those character attributes, and may correspond to the identified context parameters, including the evolution of the character's person over the course of the text, situational context, and the like. Further, previous passages may be included as context for delivery of subsequent passages. For example, dialogue from a character who has just been running may be delivered with panting, thus replicating a real-life situation. Thus, the generated audio narration may be an AI-driven narrative performance whereby natural expressiveness is woven into speech synthesis and story flow is preserved holistically, making multi-cast narration indistinguishable from a real ensemble performance.

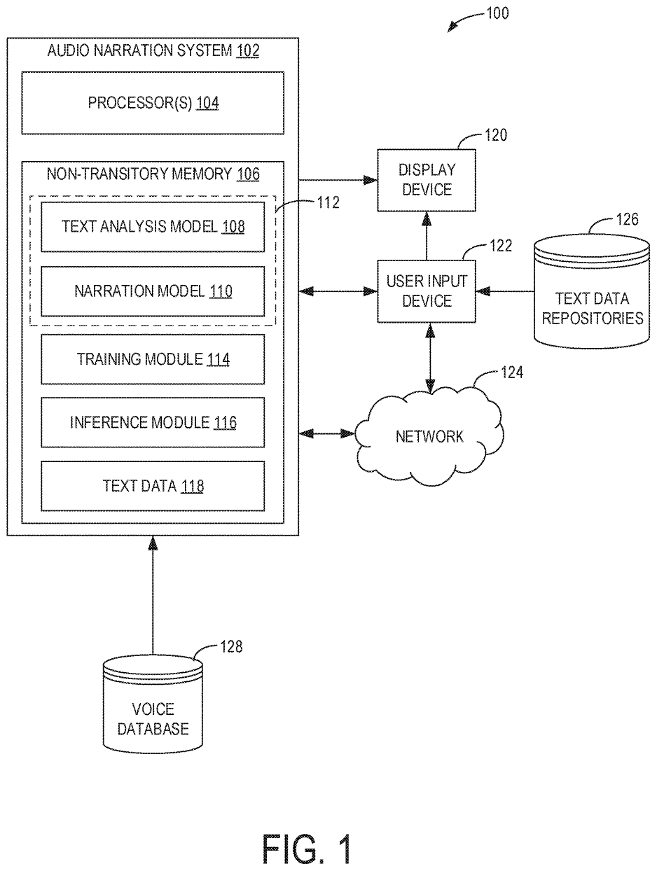

Turning now to the figures, FIG. 1 shows an AI-driven contextualized narration system 100. The system 100 may comprise an audio narration system 102, in accordance with an embodiment of the present disclosure. In some embodiments, at least a portion of the audio narration system 102 is disposed at a device (e.g., an edge device, server, etc.). The audio narration system 102 may include one or more processors 104 configured to execute machine readable instructions stored in non-transitory memory 106. Processor(s) 106 may be single core or multi-core, and the programs executed thereon may be configured for parallel or distributed processing. In some embodiments, the processor(s) 104 may optionally include individual components that are distributed throughout two or more devices, which may be remotely located and/or configured for coordinated processing. In some embodiments, one or more aspects of the processor(s) 104 may be virtualized and executed by remotely-accessible networked computing devices configured in a cloud computing configuration.

Non-transitory memory 106 may store a text analysis model 108 and narration model 110. In some examples, the text analysis model 108 and the narration model 110 may be separate AI models, such as separate deep neural networks, convolutional neural networks, or other machine learning models. In other examples, the text analysis model 108 and the narration model 110 may be incorporated into a single melded model 112. The melded model 112 may be a deep neural network, convolutional neural network, or other machine learning model. While the text analysis model 108 and the narration model 110 may at certain points be described separately, it should be understood that they may be included together as portions of the melded model 112.

The text analysis model 108 may be a trained text analysis model 108 and the narration model 110 may be a trained narration model 110, as will be further described herein. Non-transitory memory 106 may further store a network training module 114, an inference module 116, and text data 118. The text analysis model 108 may be trained to parse text data to classify passages as dialogue, narration, or narration meta elements (e.g., internal thoughts of a character, flashbacks, dream sequences, and the like). The text analysis model 108 may be further trained to identify, for each passage of the analyzed text data, one or more context parameters, including sentence structure, narrative intent, character cues, speaker identity, emotional cues, situational context/setting, and explicit emotions, and dynamically assign narrative attributes including tone, speed, emotion, pauses, and other non-verbal elements like breaths and hesitations, to each passage.

The text analysis model 108 may be deployed to analyze text data as individual passages and as sequences of passages and to consider historical narrative data when determining the one or more context parameters and assigning the narrative attributes. For example, character attributes introduced at a beginning of a narrative may be retained when determining context parameters and narrative attributes for later passages, as well as recent contexts, like recent situations or scenarios, may be used to inform the context parameters and narrative attributes. In this way, the system may preserve story flow, characterization of characters, and the like, throughout the narration.

In some embodiments, the audio narration system maintains a character performance state data structure for each identified character profile throughout processing of the text data. The character performance state data structure is a persistent, dynamically updated computational object stored in non-transitory memory that encodes a plurality of state variables for a given character at a given point in the narrative, including but not limited to: a physical state variable (e.g., encoding values corresponding to conditions such as injured, exhausted, or physically exerted); an emotional state variable (e.g., encoding values corresponding to conditions such as grieving, elated, fearful, or enraged); a relational state variable encoding the character's current interpersonal dynamic with other identified characters; and a narrative arc progression variable encoding the character's position along a detected character development trajectory. Upon processing each passage, the text analysis model updates one or more of these state variables based on the context parameters extracted from that passage and from sequences of preceding passages. The updated character performance state data structure is then passed as a conditioning input to the narration model, which maps the state variable values to corresponding acoustic parameter adjustments, such as modified pitch range, altered speaking rate, insertion of non-verbal vocalizations, or modified voice timbre, during audio synthesis of subsequent passages. Because the character performance state data structure persists across non-contiguous passages, chapters, and narration sessions, the system produces audio output that reflects the cumulative narrative history of a character without requiring explicit re-description of that history in each passage, a technical capability that is not achievable by stateless, passage-by-passage TTS processing.

In some examples, the text analysis model 108 may be configured to generate one or more narration recommendations that may then be fed into the narration model 110. For example, the narration recommendations may encompass the recommended style and delivery for the audio narration based on the text classifications (e.g., dialogue vs narration), the one or more context parameters, which may include passage specific parameters as well as the one or more narrative attributes. In some examples, each narration recommendation may be specific to a passage, whereby each passage of the text data is assigned a narration recommendation. In other examples, the narration recommendation may include therein a recommendation for each passage or for subsets of passages of the text data.

In other examples, the text analysis model 108 may be configured to provide the context parameters as specific speech parameters to the narration model 110. For example, emphasis markers for important words, pauses of variable lengths, gradual shifts in pitch, speed, and intensity, may be injected into the narration model 110, either alone or along with the context parameters, narrative attributes, and text classifications.

The narration model 110 may be deployed to generate, based on the inputted text data, an audio narration that incorporates the context parameters, narrative attributes, and text classifications as determined by the text analysis model 108. For example, the narration model 110 may take as inputs the text data and one or more narration recommendations and may output a spoken narration. As another example, the narration model 110 may take as inputs, the text data and the specific speech parameters and generate Spokane narration based thereon. In some examples, the spoken narration may be a single-cast, whereby a single voice provides the entire spoken narration. In other examples, the spoken narration may be multi-cast, whereby each character profile (e.g., each character in the narrative and the narrator) may be assigned a distinct voice. The spoken output may include intonations, inflections, tone, speed, pauses, emotions, and the like as instructed based on the analysis of the text data performed by the text analysis model 108. In this way, the spoken narration may be natural-sounding and accurately portray the narrative intent.

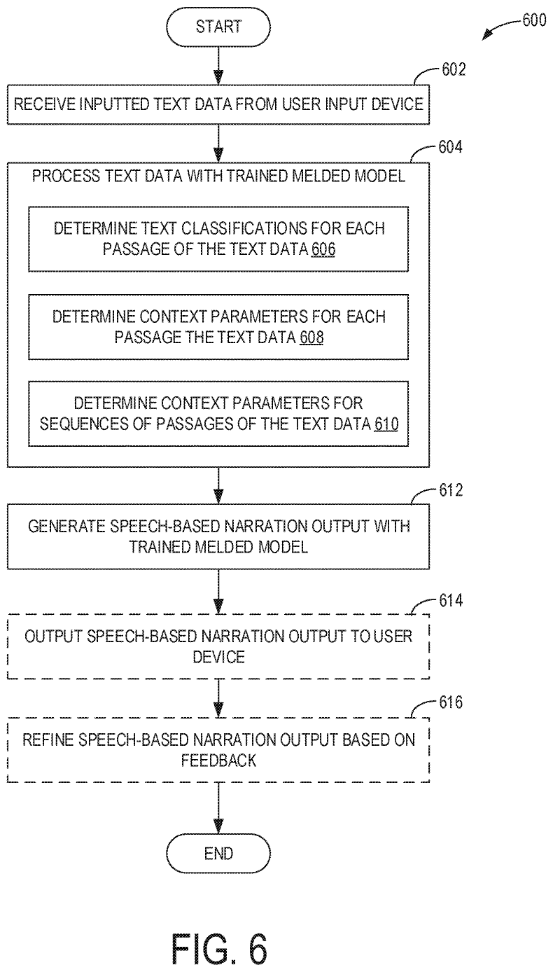

As noted, in some examples, the features of the text analysis model 108 and the narration model 110 may be incorporated together into the melded model 112. The melded model 112, as will be further described with respect to FIG. 6, may be trained on paired narrative data, where the melded model 112 learns to associate specific textual structures with their natural speech output.

Further still, in some examples, the audio narration system 102 may be configured with feedback loops. In some examples, the text analysis model 108 and the narration model 110 may be formed as part of an iterative loop, whereby the generated audio narration output is dynamically refined based on feedback from the text model. In other examples, one or both of the text analysis model 108 and the narration model 110 may receive user feedback, for example via user input device 122, requesting specific changes to the audio narration output (e.g., “make this passage more dramatic”, “reduce the volume of this passage”, etc.). Internal loop feedback and user feedback may be incorporated together, in some examples.

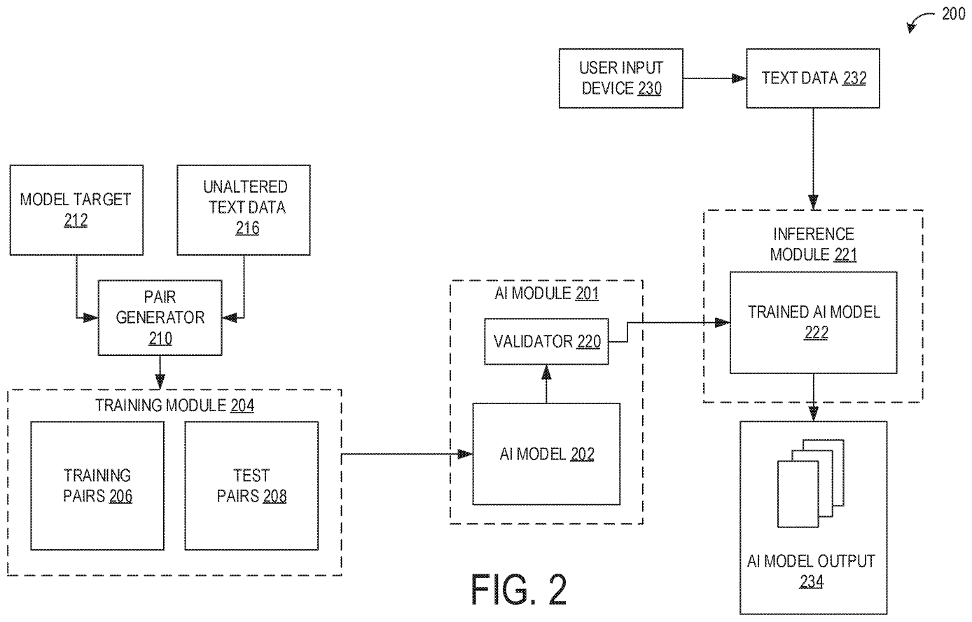

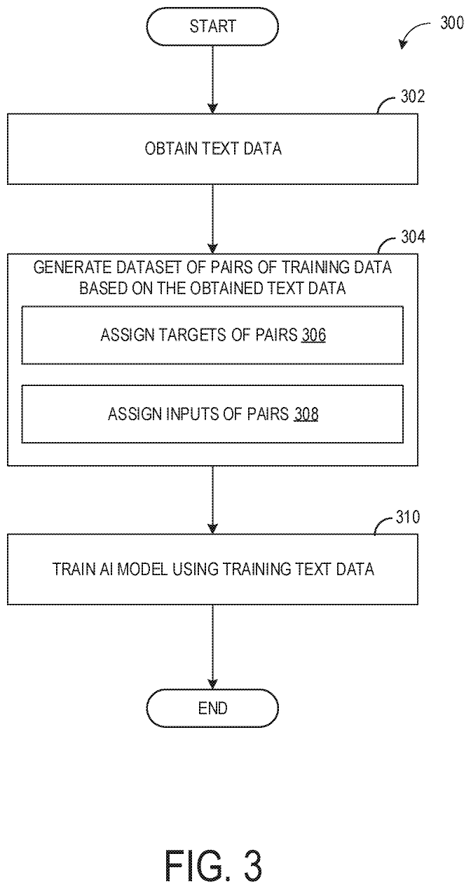

Training module 114 may comprise instructions for training one or more of the AI models of the audio narration system 102. In particular, the training module 114 may include instructions that, when executed by the processor(s) 104 cause the audio narration system 102 to conduct one or more of the steps of a method for training one or more of the text analysis model 108, the narration model 110, and the melded model 112 in a training stage, as further discussed with respect to FIGS. 2 and 3. For example, the training module 114 may access text data, in some examples portions of text data 118 stored in non-transitory memory 106. The portions of text data 118 that are accessed by the training module 114 may include written works and corresponding analysis data or human-provided narration data of the written works that may thus form training data for which the AI model(s) may be trained upon. In some embodiments, training module 114 may include instructions for implementing one or more gradient descent algorithms, applying one or more loss functions, and/or training routines, for use in adjustment parameters of the one or more AI models. Non-transitory memory 106 may also store inference module 116 that comprises instructions for analyzing new text data and generating audio narration therefor with the trained AI models.

As noted, non-transitory memory 106 further stores the text data 118. The text data 118 may include, for example, available written works, in both unaltered (e.g., raw) format and corresponding context parameters and narrative attributes therefor and/or a corresponding audio narration (e.g., a human-generated audio narration) for which one or more of the AI models herein described may be trained on. The text data 118 may additionally comprise newly acquired written works, such as those received from user input device 122 in which the audio narration system 102 is in communication with.

The audio narration system 102 may be operably and/or communicatively coupled to the user input device 122 and a display device 120. In some examples, the display device 120 may be incorporated as part of the user input device 122. The user input device 122 may comprise one or more of a touchscreen, a keyboard, a mouse, a trackpad, a motion sensing camera, or other device configured to enable a user to interact with and manipulate data within the audio narration system 102. Further, in some examples, the user input device 122 may comprise a computing device comprising one or more processors and one or more memory storing devices, wherein the computing device incorporates an input device, such as a smart phone, a tablet, a laptop computer, a desktop computer, or the like. For example, the user may provide feedback regarding a generated audio narration via the user input device 122. The display device 120 may include one or more display devices utilizing virtually any type of technology. In some embodiments, display device 120 may comprise a smart phone screen and may display one or more GUIs. As an example, the user input device 122 may include the display device 120 and may be a smart phone or tablet configured with a touchscreen display. In yet further examples, the user input device 122 may include the audio narration system 102 thereon. For example, the audio narration system 102 may be downloaded as an application and stored in memory of a smart phone. Thus, the display device 120 may be combined with the processor(s) 104, the non-transitory memory 106, and/or the user input device 122 in a shared enclosure, or may be peripheral display devices and may comprise a monitor, touchscreen, projector, or other display device known in the art, which may enable the user to view the parsed text data in one or more GUIs and/or interact with the parsed text data via the one or more GUIs.

The user input device 122 may be communicatively and/or operably coupled to one or more text data repositories 126. The one or more text data repositories 126 may comprise any database accessible by the user input device 122 from which text data may be obtained. As an example, the user input device 122 may obtain a written work from one of the one or more text data repositories 126 and may input the written work into the audio narration system 102 for generation of an audio narration. For example, the audio narration system 102, via a GUI, may prompt the user to input text data from one or more sources, such as a folder of a file explorer application, an online storage medium, or the like. In some examples, the user input device 122 may also be configured to ingest audio data (e.g., user created audio data) and then text of the audio data may be generated via a speech-to-text application either within the user input device 122 and/or the audio narration system 102.

In some examples, both the audio narration system 102 and the user input device 122 may be communicatively and/or operably coupled to a network 124. For example, the audio narration system 102 may be configured to access the network 124 in order to obtain voices from a voice database 128. The user input device 122 may be coupled to the network 124 in order to communicate with the audio narration system 102, obtain text data from the one or more text data repositories 126, and the like. The voice database 128, in some examples, may include one or more databases of available voices from which the audio narration system may choose voices to assign to various passage profiles. For example, based on the attributes of a particular character, as determined by one of the AI models, the AI model(s) may select a corresponding voice from the voice database 128 that fits with the character's profile (e.g., tone of the character, gender, etc.).

In one non-limiting example, certain portions of the audio narration system 102 may be stored locally at an edge device while others are stored within a server (e.g., a cloud-based server) such that some processes take place locally while others take place remotely. For example, the text analysis model 108 may be stored locally at an edge device. Thus, the text analysis model 108 may perform text analysis and generation of text classifications, context parameters, and character performance states locally. The narration model 110 may be stored remotely on a server such that audio synthesis and refinement occurs remotely. For example, the text analysis model 108 may analyze a provided text data set and determine text classifications of passages, context parameters of individual passages or sequences of passages, etc. locally. The text data set, the text classifications, and the context parameters may then be transmitted to the server for processing by the narration model 110. The narration model 110 may ingest the text, text classifications, and context parameters to generate an audio narration. In some examples, the narration model 110 may access external repositories such as voice database 128 for assignment of voices to character profiles. Refinements, such as reassignment of voices, to the audio narration may also occur remotely in such an example.

In another non-limiting example, both the text analysis model 108 and the narration model 110 may be stored together, for example locally at an edge device. Processes performed thereby may occur locally and the edge device may access the network 124 as needed, for example to retrieve voices for assignment or to receive user-inputted or derived performance/engagement metrics that may inform adjustments to the audio narration.

In this way, the audio narration system herein disclosed achieves a concrete technical improvement over conventional text-to-speech (TTS) systems by implementing a multi-stage, context-aware data transformation pipeline that operates on structured linguistic representations rather than on raw phonetic units. Specifically, conventional TTS systems process input text as a linear sequence of phonemes or graphemes, applying static prosodic rules derived from punctuation alone, and produce audio output without any representation of semantic or narrative context. In contrast, the audio narration system herein disclosed transforms input text data through a series of intermediate structured representations, including passage-level classification vectors, multi-dimensional context parameter sets, and character performance state objects, before any audio synthesis occurs. These intermediate representations encode semantic, emotional, and narrative relationships that are not present in the raw text and that cannot be derived by conventional phoneme-level processing. The narration model then consumes these structured intermediate representations as conditioning inputs during audio synthesis, causing the model to generate speech waveforms whose acoustic properties, including fundamental frequency contours, energy envelopes, speaking rate, and voice timbre, are dynamically modulated by the encoded context. This technical architecture constitutes a specific improvement to the functioning of speech synthesis computer systems, producing audio output with measurably different and superior acoustic characteristics compared to conventional TTS pipelines operating on the same input text, and is not merely the application of an abstract idea to a generic computer.

Turning now to FIG. 2, an example of an AI model training system 200 is shown. The AI model training system 200 herein described may be a text analysis model training system, a narration model training system, or a melded model training system. The AI model training system 200 may be an example of or incorporate the training module 114 of FIG. 1. In some examples, the AI model training system 200 may be configured to train more than one of the text analysis model 108, the narration model 110, and/or the melded model 112. The AI model training system 200 is described herein generic to the three AI model options, with specifics to each provided as options for the training system. It should be understood that the training system 200 may incorporate all the options in one system or multiple training systems 200 may exist for training individual models, in examples where the audio narration system 102 incorporates more than one AI model.

As described above, the AI model training system 200 may be implemented by an audio narration system, such as audio narration system 102 of FIG. 1, to train an AI model 202, which may be one of one or more AI models of the audio narration system, to analyze inputted text data to classify passages, determine one or more context parameters, determine narration attributes based on context, and/or to generate audio narration for the text data. In some examples, the one or more AI models of the audio narration system may be deep neural networks with a plurality of hidden layers. In one embodiment, the one or more AI models are convolutional neural networks (CNNs).

The AI model 202 may be stored within an AI module 201 of the audio narration system. The AI module 201 may be a non-limiting example of one of the text analysis model 108, the narration model 110, and the melded model 112. The training system 200 also includes a training module 204, which includes a training dataset comprising a plurality of training pairs of data, such as text data pairs divided into training pairs 206 and test pairs 208. Training module 204 may be a non-limiting example of training module 114 of the audio narration system 102 of FIG. 1.

A number of training pairs 206 and test pairs 208 may be selected to ensure that sufficient training data is available to prevent overfitting, whereby the AI model 202 learns to map features specific to samples of the training set that are not present in the test set.

Each pair of the training pairs 206 and the test pairs 208 comprises an input and a target. When the AI model 202 is the text analysis model 108, the input may be an unaltered written work and the target may be a plurality of analysis parameters corresponding to the unaltered written work. The plurality of analysis parameters may include passage classifications (e.g., dialogue, narration, meta elements, etc.) and context parameters like sentence structure, narrative intent, character cues, speaker identity, emotional cues, situational context, explicitly stated emotions, story flow/progression, and scene. The context parameters may correspond to particular passages (e.g., each passage is assigned one or more context parameters), or alternatively, for certain context parameters like story flow/progression, sequences of passages may be considered together. Alternatively, the target for the text analysis model 108 may be a narration recommendation, either for the text data as a whole or on a passage by passage basis, the narration recommendation being based on the passage classifications and context parameters. When the AI model 202 is the narration model 110, the input may be the plurality of analysis parameters or the narration recommendation and the target may be an audio narration of the text data. When the AI model 202 is the melded model 112, the input may be the unaltered text data and the target may be an audio narration of the text data that takes into account the plurality of analysis parameters. For the training pairs, the input text data may be sourced from widely available written works. In some examples, the input text data may be written works that have a corresponding audio narration (e.g., as performed by a human) thereof which may be used as the target for either the narration model 110 or the melded model 112.

The training system 200 may thus include model targets 212 and unaltered text data 216 which may be fed into the training module 204 in order to generate the training pairs 206 and test pairs 208, wherein the model targets 212 are specific to the AI model 202 as discussed above. In some examples, each of the model targets 212 may correspond to one of the unaltered text data 216, thus allowing for mapping from unaltered data to a desired target. In some examples, a pair generator 210 may be used to generate training pairs 206 and the test pairs 208 of the training module 204 from the model targets 212 and the unaltered text data 216. Data of the unaltered text data 216 may be paired with data of the model targets 212 by the pair generator 210.

Once each data pair is generated, the pair may be assigned to either the training pairs 206 or the test pairs 208. In some examples, the pair may be assigned to either the training pairs 206 or the test pairs 208 randomly in a pre-established proportion. For example, the text par may be assigned to either randomly such that 90% of the pairs generated are assigned to the training pairs 206 and 10% of the pairs generated are assigned to the test pairs 208. Alternatively, the pair may be assigned to either the training pairs 206 or the test pairs 208 randomly such that 85% of the pairs generated are assigned to the training pairs 206, and 15% of the pairs generated are assigned to the test pairs 208. It should be appreciated that the examples provided herein are for illustrative purposes, and pairs may be assigned to the training pairs 206 dataset or the test pairs 208 dataset via a different procedure and/or in a different proportion without departing from the scope of this disclosure.

The training system 200 may include a validator 220 that validates the performance of the AI model 202 against the test pairs 208. The validator 220 may take as input a partially trained AI model 202 and a dataset of test pairs 208, and may output an assessment of the performance of the partially trained AI model 202 on the dataset of test pairs 208.

Once validated, a trained AI model 222 (e.g., the validated AI model 202) may be used to generate AI model output 234 from an acquired text data 232. The acquired text data 232 may be new text data in an unaltered form that is received from a user input device 230 (e.g., user input device 122 of FIG. 1). The trained AI model 222 may be stored within an inference module 221 of the text processing system (e.g., inference module 116 of FIG. 1). The AI model output 234 may be the plurality of analysis parameters, such as passage classifications and context parameters, when the AI model is the text analysis model 108. The AI model output 234 may be an audio narration of the acquired text data 232 when the AI model is one of the narration model 110 and the melded model 112.

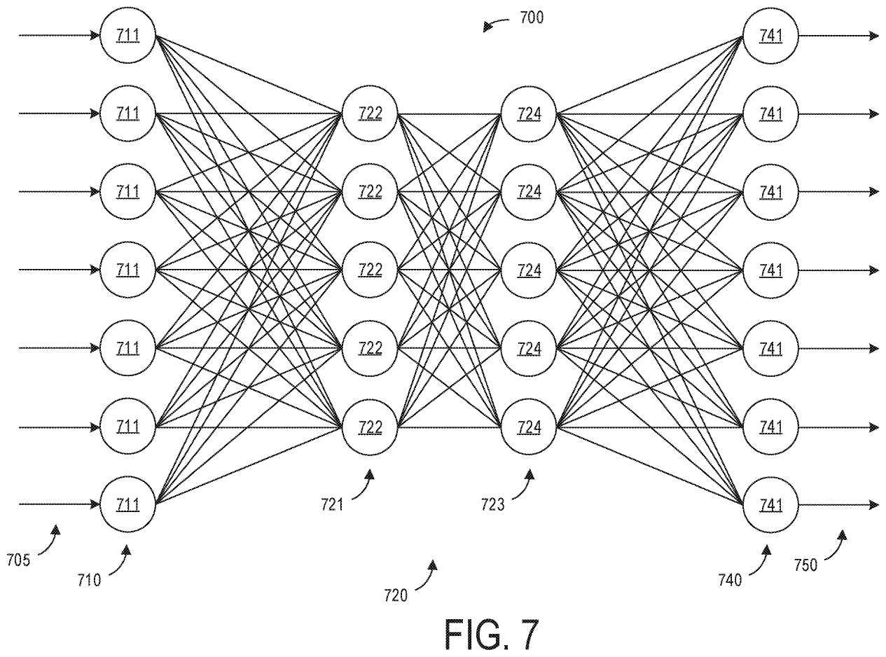

FIG. 7 shows a high-level diagram of an exemplary neural network 700. The neural network 700 may be an example of the text analysis model described with respect to FIGS. 1 and 2, though it should be understood that the neural network 700 may be implemented with other systems and components without departing from the scope of this disclosure.

Neural network 700 includes an input layer 710, a plurality of hidden layers 720 including a first hidden layer 721 and a second hidden layer 723, and an output layer 740. Each layer 710, 721, 723, and 740 includes a plurality of nodes, depicted as circles in FIG. 7. Specifically, input layer 710 includes a plurality of input nodes 711, first hidden layer 721 includes a plurality of hidden nodes 722, second hidden layer 723 includes a plurality of hidden nodes 724, and output layer 740 includes a plurality of output nodes 741. In one example, the hidden nodes 722 and 724 comprise artificial neurons (herein referred to as nodes) with non-linear activation functions that map weighted inputs to the output.

To parse text data or determine related data of text data (e.g., classify the text data) (depending on which LLM the neural network 700 is), input text data 705 are input to the neural network 700 which in turn outputs a corresponding output, such as parsed text data including a plurality of passages or classifications of the text data, including genre, category, a summary, and the like as described herein. The output may correspond to the output nodes 741 of outputs 750. More specifically, each input text data 705 is input into a corresponding input node 711 of the input layer 710. Each input node 711 is connected to each hidden node 722 of the first hidden layer 721, as depicted by the lines connecting the input layer 710 to the first hidden layer 721. Each hidden node 722 of the first hidden layer 721 is connected to each hidden node 724 of the second hidden layer 723. Each hidden node 724 is connected to each output node 741 of the output layer 740. Each output node 741 of the output layer 740 outputs to a corresponding node of outputs 750.

In one example, the hidden nodes receive one or more inputs and sum them to produce an output. The sums of each node are weighted, and the sum is passed through a non-linear activation function. The resulting output may then be passed on to each node in the following layer.

Neural network 700 may therefore comprise a feedforward neural network. In some examples, the neural network 700 may be trained through backpropagation. To minimize total error, gradient descent may be used to adjust each weight in proportion to the derivative of the error with respect to that weight. In another example, global optimization methods may be used to train the weights of the neural network 700.

It should be appreciated that, for simplicity, FIG. 7 illustrates a relatively small number of nodes, and that in practice the neural network 700 may include many thousands of nodes. As an example, while seven input nodes 711 are depicted in the input layer 710, in some examples the input layer 710 may include thousands of input nodes 711. In one example, the input layer 710 may include as many as 2,800 input nodes 711, each input node 711 configured to receive one input 705 or data variable.

Moreover, although the neural network 700 is depicted as including two hidden layers 721 and 723, it should be appreciated that the neural network 700 may include from two to x hidden layers, where x is a positive integer greater than two.

Further, the number of hidden nodes 722 in hidden layer 721 and the number of hidden nodes 724 in hidden layer 723 is optimizable. For example, the number of hidden nodes may be based on the number of outputs or output nodes 741. As an illustrative example, for a neural network model with two output nodes 741, the optimal number of hidden nodes in the hidden layers 720 may comprise two hundred hidden nodes. For two hidden layers 721 and 723, the two hundred hidden nodes may, in some examples, be distributed equally between the hidden layers such that the hidden layers have the same width. For example, hidden layer 721 may include one hundred hidden nodes 722 while hidden layer 723 may include one hundred hidden nodes 724. In contrast, for thirty output nodes 741, the optimal number of hidden nodes in the hidden layers 720 may comprise nine hundred hidden nodes. In this example, the hidden nodes may be distributed equally across the hidden layers 720, such that hidden layer 721 includes four-hundred-fifty hidden nodes 722 while hidden layer 723 includes four-hundred-fifty hidden nodes 724. Similarly, as the number of output nodes 741 in the output layer 740 is increased, the optimal number of hidden nodes may also increase.

Although constructing hidden layers with equal widths or equal numbers of hidden nodes may comprise a simplest architecture for the neural network model, it should be appreciated that in some examples, the number of hidden nodes in each hidden layer 720 may be different, such that the widths of the hidden layers are also different.

Turning now to FIG. 3, a flowchart illustrating a method 300 for training an AI model is shown. The AI model may be a non-limiting example of one of the text analysis model 108, the narration model 110, and the melded model 112, though it should be appreciated that the method 300 may be applicable to each of these models. Method 300 may be executed by a processor of a text processing system, such as the audio narration system 102 of FIG. 1. In some examples, some operations of method 300 may be stored in non-transitory memory of the text processing system (e.g., in a training module such as the training module 114 of the audio narration system 102 of FIG. 1) and executed by a processor of the text processing system (e.g., one of the processor(s) 104 of FIG. 1). The AI model may be trained on training data comprising one or more sets of pairs. When the AI model is the text analysis model 108, each pair of the one or more sets of pairs may comprise unaltered text data and a corresponding plurality of analysis parameters including passage classifications and one or more context parameters, including passage specific context parameters or passage sequence parameters. In some examples, the text analysis model 108 may additional be trained to generate a narration recommendation based on the analysis parameters. When the AI model is the narration model 110, each pair of the one or more sets of pairs may comprise one of a plurality of analysis parameters and narration recommendation(s) and a corresponding audio narration. When the AI model is the melded model 112, each pair of the one or more sets of pairs may comprise an unaltered text data and a corresponding audio narration. In some examples, the one or more sets of pairs may be stored in text data of the text processing system, such as the text data 118 of audio narration system 102 of FIG. 1.

At 302, method 300 includes obtaining text data. As described above, the text data of the text processing system may at least partially comprise existing written works, such as short stories, screen plays, chapters of books, and more that are publically available. Parsed (e.g., to classify passages as dialogue, narration, and meta element) and processed data of the existing written works may also be included in the text data of the text processing system. This text data, including both unaltered and analyzed versions as well as related data thereof, may be obtained from memory. The analyzed versions may include parameters like the context parameters described above (e.g., sentence structure, narrative intent, character cues, etc.).

At 304, method 300 includes generating a dataset of pairs of training data based on the obtained text data. Generating the dataset of pairs may comprise assigning targets of the pairs, as noted at 306, and assigning inputs of the pairs, as noted at 308. As described above, when the AI model 202 is the text analysis model 108, the inputs may be unaltered written works and the targets may be corresponding plurality of analysis parameters. The plurality of analysis parameters may include classifications (e.g., dialogue, narration, meta elements, etc.) for each passage of the corresponding written work and context parameters like sentence structure, narrative intent, character cues, speaker identity, emotional cues, situational context, explicitly stated emotions, story flow/progression, and scene. The context parameters may correspond to particular passages (e.g., each passage is assigned one or more context parameters), or alternatively, for certain context parameters like story flow/progression, sequences of passages may be considered together. Alternatively, or additionally, the targets for the text analysis model 108 may be narration recommendations, either for the written work as a whole or on a passage by passage basis, the narration recommendation being based on the passage classifications and context parameters.

When the AI model 202 is the narration model 110, the inputs may be the pluralities of analysis parameters or the narration recommendations and the targets may be corresponding audio narrations of the text data. When the AI model 202 is the melded model 112, the inputs may be the unaltered text data and the targets may be corresponding audio narrations of the text data that takes into account the plurality of analysis parameters. The audio narration target may include assignments of voices to different character profiles, in some examples. For example, a multi-cast narration may be a desired output, in which case each character profile (e.g., speaking characters and the narrator) may be assigned a different voice in the audio narration.

At 310, method 300 includes training the AI model on the training pairs. More specifically, training the AI model on the pairs includes training the AI model to learn to map from input to target. When the AI model is the text analysis model, this may include learning to map from unaltered text data to one or more of the plurality of analysis parameters and the narration recommendation. When the AI model is the narration model, this may include learning to map from the plurality of analysis parameters and/or the narration recommendation to an audio narration. When the AI model is the melded model, this may include learning to map from unaltered text data to an audio narration. The audio narration target may include assignments of voices to different character profiles, in some examples. For example, a multi-cast narration may be a desired output, in which case each character profile (e.g., speaking characters and the narrator) may be assigned a different voice in the audio narration. In some examples, the AI model may comprise a generative neural network. In some examples, the AI model may comprise a generative neural network having a U-net architecture. In yet other examples, the AI model may include one or more convolutional layers, which in turn comprise one or more convolutional filters (e.g., a convoluted neural network architecture).

With respect to training an AI model, such as the text analysis model, the narration model, or the melded model, the convolutional filters of the architecture may comprise a plurality of weights, wherein the values of the weights are learned during a training procedure. The convolutional filters may correspond to one or more features/patterns, thereby enabling the AI model to, for example when the AI model is the text analysis model, identify and extract features from the text data to classify passages and identify and characterize context parameters like sentence structure, narrative intent, character cues, speaker identity, emotional cues, situational context, explicitly stated emotions, story flow/progression, and scene setting. Each of these context parameters may inform how a corresponding audio narration should sound. In other examples, the AI model may not be a convolutional neural network, rather may be a different type of neural network.

Training an AI model (e.g., the text analysis model, the narration model, and/or the melded model) on the training pairs may include iteratively inputting text data of each text data pair into an input layer of the AI model. The AI model may map the input text data to a corresponding target by propagating the input text data from the input layer, through one or more hidden layers, until reaching an output layer of the AI model. In the example of the text analysis model, the output may be the plurality of analysis parameters as herein described. In the example of the narration model, the output may be an audio narration, which may be single-cast or multi-cast. As described above, the parsed text data may comprise one or more passages that are separated and identified by passage profile, whereby individual passages are assigned to a particular character, narrator, or other. The parsed text data may thus be outputted for further processing by the text processing system and/or assignment of voices for audio narration.

The AI models may be configured to iteratively adjust one or more of the plurality of weights of the AI models in order to minimize a loss function, based on an assessment of differences between the input text data and the target text data comprised by each pair of the training pairs. In some examples, the loss function is a Mean Absolute Error (MAE) loss function, where differences between the input text data and the target text data are compared on a pixel-by-pixel basis and summed. In another embodiment, the loss function may be a Structural Similarity Index (SSIM) loss function. In other embodiments, the loss function may be a minimax loss function, or a Wasserstein loss function. It should be appreciated that the examples provided herein are for illustrative purposes, and other types of loss function may be used without departing from the scope of this disclosure.

The weights and biases of a given AI model may be adjusted based on a difference between the output text data and the target (e.g., ground truth) text data of the relevant text data pair. The difference (or loss), as determined by the loss function, may be backpropogated through the neural learning network to update the weights (and biases) of the convolutional layers. In some examples, back propagation of the loss may occur according to a gradient descent algorithm, wherein a gradient of the loss function (a first derivative, or approximation of the first derivative) is determined for each weight and bias of the deep neural network. Each weight (and bias) of the AI model is then updated by adding the negative of the product of the gradient determined (or approximated) for the weight (or bias) with a predetermined step size. Updating of the weights and biases may be repeated until the weights and biases of the AI model converge, or the rate of change of the weights and/or biases of the deep neural network for each iteration of weight adjustment are under a threshold.

In order to avoid overfitting, training of the given AI model may be periodically interrupted to validate a performance of the AI model on the test data pairs. In some examples, training of the AI model may end when a performance of the AI model on the test data pairs converges (e.g., when an error rate on the test set converges on or to within a threshold of a minimum value). In this way, the AI model may be trained to generate parsed text data, as herein described.

In some embodiments, an assessment of the performance of the given AI model may include a combination of a minimum error rate and a quality assessment, or a different function of the minimum error rates achieved on each text data pair of the test data pairs and/or one or more quality assessments, or another factor for assessing the performance of the AI model. It should be appreciated that the examples provided herein are for illustrative purposes, and other loss functions, error rates, quality assessments, and/or performance assessments may be included without departing from the scope of this disclosure.

In some examples, training an AI model, such as the text analysis model, the narration model, and/or the melded model, may incorporate a feedback loop, as will be further described herein. For example, end-user actions with the output of the trained AI model, such as user interaction metrics (e.g., listening rates, drop-off points, etc.) or direct user feedback (e.g., input such as “make this passage more dramatic”), may be fed back into the AI model during training. For example, user engagement metrics may be fed back into training of the audio narration model for adaptation of narration parameters like tone, pacing, voice selection, and the like based on the user engagement metrics. Alternatively, or additionally, the text analysis model and the narration model may be included together in an iterative loop, whereby an output of the text analysis model is fed into the narration model, and an output of the narration model is fed back into the text analysis model where the text analysis model provides feedback regarding the output of the narration model. In this way, the AI models may be adaptively updated based on user interactions with the outputs thereof.

As a non-limiting example, the feedback loop may provide dynamic real-time feedback for one or more AI models that provide audio narration based on the analysis parameters. For example, the training process of one or more of the AI models may be updated in an iterative manner to continually improve outputs thereof.

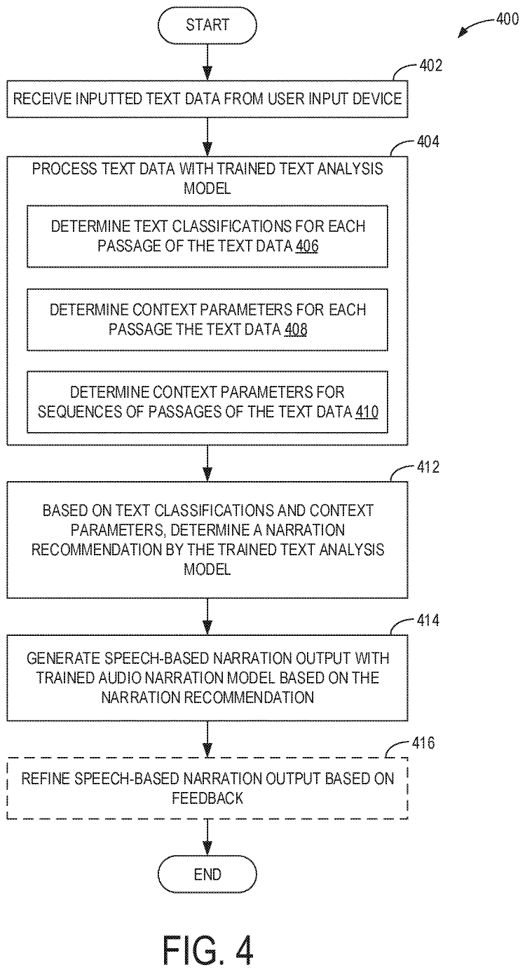

Referring now to FIG. 4, a flowchart illustrating a method 400 for generating an audio narration from inputted text data using one or more AI models is shown, according to a first embodiment of the present disclosure. For example, the audio narration may be generated via a combination of a trained text analysis model and a trained audio narration model, such as the text analysis model 108 and the narration model 110 of FIG. 1. In the first embodiment, the text analysis model and the audio narration model may be configured as part of an iterative loop. Method 400 may be executed by a processor of a text processing system, such as the audio narration system 102 of FIG. 1. In some examples, some operations of method 400 may be stored in non-transitory memory of the audio narration system and executed by the processor of the audio narration system (e.g., one of the processor(s) 104 of FIG. 1). The AI models may each be trained on training data comprising one or more sets of pairs as described with respect to FIG. 3.

At 402, method 400 includes receiving inputted text data from a user input device. As described with respect to FIG. 1, the audio narration system may be communicatively and/or operably coupled to the user input device, such as a desktop computer, laptop computer, smart phone, tablet, etc. The user input device may be configured to access one or more text data repositories that store written works. For example, the user input device may comprise non-transitory memory in which text data is stored. In other examples, the user input device may be configured to access one or more cloud platforms in which the text data is stored. The text data may be transmitted from the one or more text data repositories to the user input device and from the user input device to the text processing system.

At 404, method 400 includes processing the text data with the trained text analysis model. As described above, the trained text analysis model may be trained to output a plurality of analysis parameters, including passage classifications and context parameters. Thus, processing the text data may include determining text classifications for each passage of the text data, as noted at 406. For example, each passage of the text data may be classified as dialogue, narration, or as including meta-narration elements (e.g., internal character thoughts, a flashback scene, a dream sequence, etc.).

Processing the text data may additionally include determining the context parameters, which may include sentence structure, narrative intent, character cues, speaker identity, emotional cues, situational context, explicitly stated emotions, story flow/progression, and/or scene setting. Some of the context parameters may be determined for each passage of the text data, as noted at 408, and some of the context parameters may be determined for sequences of passages of the text data, as noted at 410. For example, a speaker identity may be determined for each passage, whereas a progression of a conversation may be considered over the course of a sequence of passages, thereby allowing for determination of tone over the course of the conversation. Analysis of sequences of passages in this way may ensure smooth transitions between paragraphs and dialogue, for example adjusting tone dynamically across conversations, modulating character's voices as the story progresses (e.g., thereby demonstrating that a character gets more tired over the course of a battle scene, or becomes more confident per the character's arc, etc.), and retaining memory of prior events (e.g., if a character was gasping from running, they should still sound breathless in the next sentence).

At 412, method 400 includes, based on the text classifications and context parameters, determining one or more narration recommendations by the trained text analysis model. In one example, the narration recommendations may comprise a narration recommendation for each passage of the text data. In another example, the narration recommendation may be a single recommendation that encompasses recommendations for each passage therewithin. As an example, the narration recommendation may comprise, for a passage, a speaker identity, a tone of the passage (e.g., tense, calm, dramatic, loud, quiet, etc.), and the like that may inform the narration model how to narrate that passage. For example, the narration recommendation may indicate a character performance state (e.g., emotionally fatigued, stressed, confident, injured, etc.) for a given passage that may inform the tone that is reflected in the delivery of that passage. The character performance states may persist across non-contiguous passages, chapters, or narration sessions and may influence subsequent narration. For example, throughout the course of a conversation between two characters, interspersed with narrator passages, the character performance state of a given character may be maintained or may evolve based on context clues.

At 414, method 400 includes generating a speech-based narration output (e.g., an audio narration output) with the trained audio narration model based on the narration recommendation. As described herein, the narration model may be trained to ingest one or both of the analysis parameters (e.g., the text classifications and context parameters) and the narration recommendation outputted by the trained text analysis model and output an audio narration based thereon.

The narration recommendations may inform the narration model how to deliver each passage. The narration recommendations may take into account the text classifications and context parameters determined by the text analysis model, as described above. Thus, the narration model may generate an audio narration for the text data that includes character-specific voice traits and intonations that dynamically reflect the context parameters associated with respective passages. For example, the audio narration may include voice traits and tone that correspond to scene, setting, and emotional context, and respects the narrative intent and sentence structure of the text data. In this way, the generated audio narration may be a more natural sounding output compared to traditional TTS outputs.

As described above, a traditional TTS application processes each input separately, resulting in static voices that may not match the setting, scene, or characterization of characters. In contrast, the text analysis model and the narration model herein disclosed may generate an audio narration from the inputted text that accounts for these context clues in the text. By generating an audio narration with passage delivery that maintains character performance states over time (e.g., over non-contiguous passages, chapters, or narration sessions) and updates the delivery based on context parameters, the system provides a more natural sounding audio narration, increasing the user's experience.

In some examples, the emotional load or emotional intensity of a passage may be included within the determined context parameters associated with that passage. When the detected emotional intensity of a passage exceeds a predefined threshold, the delivery of the passage may be modified to match the detected emotional intensity without altering the text of the passage. For example, delivery may be softened, slowed, sped up, made louder, etc. to correspond with the emotional load of the passage. As an example, during a scene where two characters are having an argument, the emotional intensity of the scene may exceed a threshold and thus the delivery of passages by one or more of the characters may reflect the intensity. The manner in which the delivery is changed may be based on the context parameters. For example, during an argument, passages may be increased in volume while during a funeral or death bed scene, passages may be softened and slowed.

At 416, method 400 optionally includes refining the speech-based narration output based on feedback. In one example, the generated audio narration may be fed back into the text analysis model, whereby the text analysis model may generate a feedback, identifying passages that should be delivered differently, errors in speaker identity, and the like. If such feedback is determined by the text analysis model, the feedback may be fed back into the narration model as part of an iterative feedback loop. The process may repeat until no additional feedback is determined, in which case the generated audio narration may be outputted to a user.

In another example, a generated audio narration may be outputted to a user and the user may provide user-inputted feedback. For example, via a user input device, the user may identify passages of the audio narration that the user wishes to be different. The user may input feedback such as “make this passage more dramatic” or “this passage corresponds to a first character, not a second character”. In some examples, the narration model may ingest the user feedback and update the generated audio narration in response to the user feedback. In another example, the user feedback may be used to update the training of one or both of the text analysis model and the narration model. Thus, the model(s) may learn from user feedback.

In yet another example, performance and/or engagement metrics may be used for refinement. For example, aggregated listener engagement metrics such as drop-off rates, replays, and completion rates may inform user preferences and narration parameters such as tone, pacing, intensity, voice selection, and the like may be iteratively adapted. In some examples, the performance and/or engagement metrics may be fed into the training system of the audio narration model, as described above with respect to FIG. 3, such that future narration outputs apply the adapted narration parameters. In other examples, the performance and/or engagement metrics may be used to iteratively update parameters, such as assigned voices and passage deliveries, for a previously generated narration. For example, at 30% of the way through a book, a new character may be introduced. Performance and/or engagement metrics may indicate an increased drop-off rate after 30%. For example, the assigned voice for the newly introduced character or passage delivery by that assigned voice may be off-putting to listeners, causing listeners to more often stop listening after introduction of the new character. In response to receiving this aggregated listener behavior data, the audio narration model may update the audio narration to reassign a different voice to that character and/or change passage delivery by the previously assigned voice for that character.

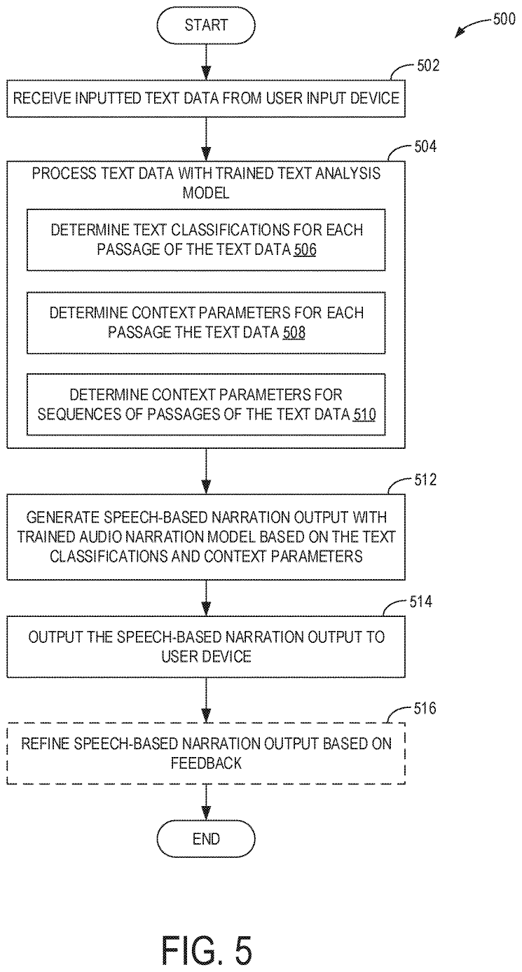

Referring now to FIG. 5, a flowchart illustrating a method 500 for generating an audio narration from inputted text data using one or more AI models is shown, according to a second embodiment of the present disclosure. For example, the audio narration may be generated via a combination of a trained text analysis model and a trained audio narration model, such as the text analysis model 108 and the narration model 110 of FIG. 1. The second embodiment may include dynamic speech parameter injection from text context. Method 500 may be executed by a processor of a text processing system, such as the audio narration system 102 of FIG. 1. In some examples, some operations of method 500 may be stored in non-transitory memory of the audio narration system and executed by the processor of the audio narration system (e.g., one of the processor(s) 104 of FIG. 1). The AI models may each be trained on training data comprising one or more sets of pairs as described with respect to FIG. 3.

At 502, method 500 includes receiving inputted text data from a user input device. As described with respect to FIG. 1, the audio narration system may be communicatively and/or operably coupled to the user input device, such as a desktop computer, laptop computer, smart phone, tablet, etc. The user input device may be configured to access one or more text data repositories that store written works. For example, the user input device may comprise non-transitory memory in which text data is stored. In other examples, the user input device may be configured to access one or more cloud platforms in which the text data is stored. The text data may be transmitted from the one or more text data repositories to the user input device and from the user input device to the text processing system.

At 504, method 500 includes processing the text data with the trained text analysis model. As described above, the trained text analysis model may be trained to output a plurality of analysis parameters, including passage classifications and context parameters. Thus, processing the text data may include determining text classifications for each passage of the text data, as noted at 506. For example, each passage of the text data may be classified as dialogue, narration, or as including meta-narration elements (e.g., internal character thoughts, a flashback scene, a dream sequence, etc.).

Processing the text data may additionally include determining the context parameters, which may include sentence structure, narrative intent, character cues, speaker identity, emotional cues, situational context, explicitly stated emotions, story flow/progression, and/or scene setting. Some of the context parameters may be determined for each passage of the text data, as noted at 508, and some of the context parameters may be determined for sequences of passages of the text data, as noted at 510. For example, a speaker identity may be determined for each passage, whereas a progression of a conversation may be considered over the course of a sequence of passages, thereby allowing for determination of tone over the course of the conversation. Analysis of sequences of passages in this way may ensure smooth transitions between paragraphs and dialogue, for example adjusting tone dynamically across conversations, modulating character's voices as the story progresses (e.g., thereby demonstrating that a character gets more tired over the course of a battle scene, or becomes more confident per the character's arc, etc.), and retaining memory of prior events (e.g., if a character was gasping from running, they should still sound breathless in the next sentence).

At 512, method 500 includes based on the text classifications and context parameters, generating a speech-based narration output (e.g., an audio narration) with the trained audio narration model. In contrast to the first embodiment described with respect to FIG. 4, the audio narration model may generate the audio narration output based directly on the analysis parameters (e.g., the text classifications and context parameters) rather than based on one or more narration recommendations. In the second embodiment, the text analysis model may inject the analysis parameters as specific speech parameters directly into the narration model, wherein the analysis parameters include emphasis markers for important words, pauses of variable lengths, gradual shifts in pitch, speed, and intensity that are included in the context parameters.

Context parameters like sentence structure, narrative intent, and character cues (including speaker identity) may inform generated speech variations in tone, speed and delivery of the generated audio narration. For example, a passage identified as a question may be narrated in the audio narration with a rising intonation, while a passage identified as a rhetorical question from a sarcastic character may be narrated in the audio narration with a deadpan or sarcastic intonation. In some examples, the context parameters may include an overall scene mood and dynamic cues may inform adjustment of delivery based on context shifts.

Context clues including emotional cues, situational context, and explicitly stated emotions may inform how the narration model delivers passages in the generated audio narration. For example, a battle scene may be delivered in the generated audio narration in a rapid, intense manner. In contrast, a funeral scene may be delivered in the generated audio narration in a somber, slow manner. In this way, the audio narration model may use the context parameters to insert pacing and rhythm to the generated audio narration. Further, based on situational context, scene setting context parameters, and explicitly stated clues, the audio narration model may insert natural speech patterns like sighs, gasps, hesitations, nervous laughter, scoffs, and the like to replicate natural speech and enhance dramatic effect.

Further, the narration model may assign voices to characters based on the character cues and identified speaker identities. For example, character cues may indicate that a character is soft-spoken and nervous. The narration model may use this information to assign a voice that matches those characteristics. Further, the text classifications may inform intonation of different passages in the generated audio narration. In this way, the generated audio narration may be a multi-cast narration.

The context parameters that are determined based on sequences of passage may be used by the audio narration model for adaptive delivery evolution. For example, characters may change over time. A character may become more confident over the course of the story, a character may be injured at some point or gradually heal from an injury, etc. These situational context clues may be inputted into the audio narration model and the audio narration model may modulate character voices in the generated audio narration to reflect these evolutions. Further, context parameters for sequences of passages may allow for delivery in the generated audio narration that retains vibe and tone from previous passages. For example, a character who just received bad news may sound emotional/upset in a following dialogue passage. In some examples, the emotional load or emotional intensity of a passage may be included within the determined context parameters associated with that passage. When the detected emotional intensity of a passage exceeds a predefined threshold, the delivery of the passage may be modified to match the detected emotional intensity without altering the text of the passage. For example, delivery may be softened, slowed, sped up, made louder, etc. to correspond with the emotional load of the passage. As an example, during a scene where two characters are having an argument, the emotional intensity of the scene may exceed a threshold and thus the delivery of passages by one or more of the characters may reflect the intensity. The manner in which the delivery is changed may be based on the context parameters. For example, during an argument, passages may be increased in volume while during a funeral or death bed scene, passages may be softened and slowed.

In some examples, scene setting and situational context may additionally be used to add spatial effects and ambient noise dynamically. For example, echo effects may be included in the generated audio narration for passages that correspond to scenes in a cave, distant murmuring sounds may be included for passages that correspond to a scene where a character is eavesdropping, and the like.

In some embodiments, the dynamic speech parameter injection of the second embodiment is implemented via a cross-attention conditioning mechanism within the neural network architecture of the narration model. Specifically, the text analysis model may output a context parameter tensor for each passage, wherein the tensor encodes numerical representations of the determined context parameters, including emphasis weight values for individual tokens, pause duration values at designated token boundaries, pitch trajectory vectors defining gradual shifts in fundamental frequency, speaking rate scalar values, and intensity envelope parameters. This context parameter tensor is injected into one or more cross-attention layers of the narration model, where it functions as a key-value input that modulates the attention weights applied to the text token embeddings during audio synthesis. As a result, the narration model's audio synthesis process is conditioned at the token level by the injected speech parameters, causing the generated acoustic features of each synthesized speech segment to be directly and specifically influenced by the corresponding context parameter values. This injection mechanism is technically distinct from post-processing approaches that apply prosodic modifications to a fully synthesized audio waveform, because the parameter injection occurs during the synthesis process itself, enabling the model to generate acoustic features that are organically integrated rather than artificially superimposed. The cross-attention conditioning architecture thus provides a specific, concrete technical implementation of context-aware speech synthesis that produces a measurably different computational output (e.g., in terms of the acoustic feature distributions of the generated audio) compared to narration models that do not employ such conditioning.

At 514, method 500 includes outputting the speech-based narration output to a user device. In some examples, the user device may be the user input device from which the text data was obtained at 502. For example, an author may input their written work for audio narration via the user input device, deploy the AI models herein described to generate the audio narration, and then view/listen to the audio narration via the same user input device. In other examples, the user device may be a different user device. For example, the AI models may be included in a mobile application, the audio narration system being accessible in a distributed manner via a plurality of devices that execute the mobile application. The generated audio narration of the text data may be outputted via the application (e.g., published) and may be accessible by a variety of users using the application.

At 516, method 500 optionally includes refining the speech-based narration output based on feedback. The feedback may include user-inputted feedback. For example, via the user input device, the user (e.g., the author) may identify passages of the audio narration that the user wishes to be different. The user may input feedback such as “make this passage more dramatic” or “this passage corresponds to a first character, not a second character”. In some examples, the narration model may ingest the user feedback and update the generated audio narration in response to the user feedback. In another example, the user feedback may be used to update the training of one or both of the text analysis model and the narration model. Thus, the model(s) may learn from user feedback.

Referring now to FIG. 6, a flowchart illustrating a method 600 for generating an audio narration from inputted text data using an AI model is shown, according to a third embodiment of the present disclosure. For example, the audio narration may be generated via a melded model that incorporates text analysis features and audio generation features, such as the melded model 112 of FIG. 1. Method 600 may be executed by a processor of a text processing system, such as the audio narration system 102 of FIG. 1. In some examples, some operations of method 400 may be stored in non-transitory memory of the audio narration system and executed by the processor of the audio narration system (e.g., one of the processor(s) 104 of FIG. 1). The AI model may each be trained on training data comprising one or more sets of pairs as described with respect to FIG. 3.

At 602, method 600 includes receiving inputted text data from a user input device. As described with respect to FIG. 1, the audio narration system may be communicatively and/or operably coupled to the user input device, such as a desktop computer, laptop computer, smart phone, tablet, etc. The user input device may be configured to access one or more text data repositories that store written works. For example, the user input device may comprise non-transitory memory in which text data is stored. In other examples, the user input device may be configured to access one or more cloud platforms in which the text data is stored. The text data may be transmitted from the one or more text data repositories to the user input device and from the user input device to the text processing system.

At 604, method 600 includes processing the text data with the trained melded model. As described above, the trained melded model may be trained to determine a plurality of analysis parameters, including passage classifications and context parameters. Thus, processing the text data may include determining text classifications for each passage of the text data, as noted at 606. For example, each passage of the text data may be classified as dialogue, narration, or as including meta-narration elements (e.g., internal character thoughts, a flashback scene, a dream sequence, etc.).

Processing the text data may additionally include determining the context parameters, which may include sentence structure, narrative intent, character cues, speaker identity, emotional cues, situational context, explicitly stated emotions, story flow/progression, and/or scene setting. Some of the context parameters may be determined for each passage of the text data, as noted at 608, and some of the context parameters may be determined for sequences of passages of the text data, as noted at 610. For example, a speaker identity may be determined for each passage, whereas a progression of a conversation may be considered over the course of a sequence of passages, thereby allowing for determination of tone over the course of the conversation. Analysis of sequences of passages in this way may ensure smooth transitions between paragraphs and dialogue, for example adjusting tone dynamically across conversations, modulating character's voices as the story progresses (e.g., thereby demonstrating that a character gets more tired over the course of a battle scene, or becomes more confident per the character's arc, etc.), and retaining memory of prior events (e.g., if a character was gasping from running, they should still sound breathless in the next sentence).

At 612, method 600 includes generating a speech-based narration output (e.g., an audio narration) with the trained melded model. As described above, the melded model may be trained to ingest the text data and generate an audio narration of the text data that accounts for the text classifications and context parameters. For example, as described above, the context parameters like sentence structure, narrative intent, and character cues may inform generated speech variations in tone, speed, and delivery of passages. Context clues including emotional cues, situational context, and explicitly stated emotions may inform how the narration model delivers passages in the generated audio narration, in terms of intensity, voice quality, and the like. Further, based on situational context, scene setting context parameters, and explicitly stated clues, the melded model may insert natural speech patterns like sighs, gasps, hesitations, nervous laughter, scoffs, and the like to replicate natural speech and enhance dramatic effect.

Further, the melded model may assign voices to characters based on character cues and identified speaker identities. In this way, the generated audio narration may be a multi-cast narration.

Further, the melded model may dynamically alter vocal delivery as a story evolves, for example based on analysis of sequences of passages and/or story progression. In this way, the generated audio narration may be delivered in a way that retains vibe and tone from previous passages in the same conversation or over the course of a scene. In some examples, scene setting and situational context may additionally be used to add spatial effects and ambient noise dynamically. For example, echo effects may be included in the generated audio narration for passages that correspond to scenes in a cave, distant murmuring sounds may be included for passages that correspond to a scene where a character is eavesdropping, and the like.

At 614, method 600 includes outputting the speech-based narration output to a user device. In some examples, the user device may be the user input device from which the text data was obtained at 502. For example, an author may input their written work for audio narration via the user input device, deploy the AI models herein described to generate the audio narration, and then view/listen to the audio narration via the same user input device. In other examples, the user device may be a different user device. For example, the AI models may be included in a mobile application, the audio narration system being accessible in a distributed manner via a plurality of devices that execute the mobile application. The generated audio narration of the text data may be outputted via the application (e.g., published) and may be accessible by a variety of users using the application.

At 616, method 600 optionally includes refining the speech-based narration output based on feedback. The feedback may include user-inputted feedback. For example, via the user input device, the user (e.g., the author) may identify passages of the audio narration that the user wishes to be different. The user may input feedback such as “make this passage more dramatic” or “this passage corresponds to a first character, not a second character”. In some examples, the narration model may ingest the user feedback and update the generated audio narration in response to the user feedback. In another example, the user feedback may be used to update the training of one or both of the text analysis model and the narration model. Thus, the model(s) may learn from user feedback.

The technical effect of the systems and methods herein provided is that text data may be converted to an audio narration that incorporates the context of the text data, thereby providing a more natural sounding narration. In particular, the audio narration system herein disclosed identifies a text classification (e.g., dialogue vs narration) of each passage of the text data and identifies one or more context parameters of each passage as well as sequences of passages. Thus, the audio narration may be generated in a manner that accounts for sentence structure, narrative intent, character cues, speaker identity, emotional cues, situational context, explicitly stated emotions, story flow/progression, and scene setting. Because the system identifies speaker identity within the text data, the system may be configured for adaptive AI-generated multi-cast narration. Further, the system may be an expressive storytelling system, whereby the system accounts for the emotional context, story progression, and characterization of characters when generating the audio narration. The system may assign voices based on characterization of each character profile and is thus provides a context-aware voice performance.

The disclosure also provides support for an audio narration system, comprising: a processor communicably coupled to non-transitory memory storing one or more aI models, the non-transitory memory including instructions that when executed cause the processor to: receive text data comprising a plurality of passages from a user input device, process the text data with the one or more aI models to determine text classifications of each passage of the plurality of passages of the text data and one or more context parameters, generate an audio narration with the one or more aI models based on the text classifications of each passage of the plurality of passages and the one or more context parameters, wherein a delivery of a given passage in the audio narration reflects the text classification thereof and the one or more context parameters of the given passage, and output the audio narration to the user input device. In a first example of the system, the one or more AI models comprise a text analysis model and an audio narration model. In a second example of the system, optionally including the first example, the one or more context parameters are determined for one or more of each passage of the text data and sequences of passages of the text data. In a third example of the system, optionally including one or both of the first and second examples, the delivery of the given passage is further based on historical narrative data, whereby prior events relating to a corresponding character affect the delivery of a later passage without explicit description in the later passage. In a fourth example of the system, optionally including one or more or each of the first through third examples, the processor is further configured to, via the text analysis model, generate one or more narration recommendations based on the text classifications and the one or more context parameters. In a fifth example of the system, optionally including one or more or each of the first through fourth examples, the processor is further configured to, via the audio narration model, generate the audio narration based on the one or more narration recommendations. In a sixth example of the system, optionally including one or more or each of the first through fifth examples, the processor is further configured to dynamically modify the delivery when a detected emotional intensity of a passage exceeds a predefined threshold without modifying text of the passage. In a seventh example of the system, optionally including one or more or each of the first through sixth examples, the delivery also reflects auxiliary non-textual inputs in combination with text-derived content comprising the text classifications the and one or more context parameters.

The disclosure also provides support for a method for an audio narration system, comprising: receiving text data, wherein the text data comprises a plurality of passages, determining text classifications for the plurality of passages, wherein each passage of the plurality of passages is classified as one of dialogue, narration, and a meta-narration element, determining one or more context parameters of the text data, wherein the one or more context parameters are determined for each passage of the plurality of passages and one or more of the context parameters are determined for sequences of passages of the plurality of passages, generating an audio narration based on the text classifications and the one or more context parameters. wherein the audio narration retains narrative context, character identity, and delivery attributes across passages based on the text classifications and the one or more context parameters, and outputting the audio narration to a user device. In a first example of the method, determining the text classifications and the one or more context parameters comprises deploying a trained text analysis model. In a second example of the method, optionally including the first example, the method further comprises: generating one or more narration recommendations with the trained text analysis model based on the text classifications and the one or more context parameters. In a third example of the method, optionally including one or both of the first and second examples, generating the audio narration comprises deploying a trained narration model, wherein the trained narration model is configured to ingest the one or more narration recommendations and output the audio narration based on the one or more narration recommendations. In a fourth example of the method, optionally including one or more or each of the first through third examples, generating the audio narration comprises deploying a trained narration model, wherein the trained narration model is configured to ingest the text classifications and the one or more context parameters and output the audio narration based on the text classifications and the one or more context parameters. In a fifth example of the method, optionally including one or more or each of the first through fourth examples, the method further comprises: assigning one or more voices to the plurality of passages based on the text classifications and the one or more context parameters, wherein the one or more context parameters comprise at least speaker identity for each of the plurality of passages. In a sixth example of the method, optionally including one or more or each of the first through fifth examples, the one or more context parameters comprise one or more of sentence structure, narrative intent, character cues, speaker identity, emotional cues, situational context, explicitly stated emotions, story flow/progression, and scene setting.

The disclosure also provides support for an audio narration system, comprising: a local processing component disposed at an edge device, the edge device comprising non-transitory memory storing a text analysis model and instructions that when executed cause a first processor of the edge device to: receive text data from a user input device communicatively coupled to the edge device, and process the text data with the text analysis model determine, locally at the edge device, text classifications for each passage of the text data and one or more context parameters for one or more of each passage of the text data and sequences of passages of the text data, and a text narration model stored remotely in a server, wherein the text narration model is configured to ingest the text data, the text classifications for each passage of the text data, and the one or more context parameters, and generate an audio narration of the text data based on the text classifications for each passage of the text data and the one or more context parameters, and transmit the audio narration to the edge device for output via the user input device. In a first example of the system, the text narration model is configured to adapt narration parameters for future narration outputs based on aggregated listener engagement metrics. In a second example of the system, optionally including the first example, the text narration model is configured to access a voice database via the server to obtain one or more voices and assign a voice to each character profile identified in the text classifications and the one or more context parameters. In a third example of the system, optionally including one or both of the first and second examples, the text narration model is configured to reassign a voice to a character profile based on one or more of performance metrics and engagement metrics for the audio narration. In a fourth example of the system, optionally including one or more or each of the first through third examples when generating the audio narration, the text narration model defines character performance states based on the text classifications, wherein the character performance states persist across non-contiguous passages and evolve dynamically based on the one or more context parameters.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property. The terms “including” and “in which” are used as the plain-language equivalents of the respective terms “comprising” and “wherein.” Moreover, the terms “first,” “second,” and “third,” etc. are used merely as labels, and are not intended to impose numerical requirements or a particular positional order on their objects.

This written description uses examples to disclose the invention, including the best mode, and also to enable a person of ordinary skill in the relevant art to practice the invention, including making and using any devices or systems and performing any incorporated methods. The patentable scope of the invention is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

1. An audio narration system, comprising:
a processor communicably coupled to non-transitory memory storing one or more AI models, the non-transitory memory including instructions that when executed cause the processor to:
receive text data comprising a plurality of passages from a user input device;
process the text data with the one or more AI models to determine text classifications of each passage of the plurality of passages of the text data and one or more context parameters;
generate an audio narration with the one or more AI models based on the text classifications of each passage of the plurality of passages and the one or more context parameters, wherein a delivery of a given passage in the audio narration reflects the text classification thereof and the one or more context parameters of the given passage; and
output the audio narration to the user input device.

2. The audio narration system of claim 1, wherein the one or more AI models comprise a text analysis model and an audio narration model.

3. The audio narration system of claim 1, wherein the one or more context parameters are determined for one or more of each passage of the text data and sequences of passages of the text data.

4. The audio narration system of claim 1, wherein the delivery of the given passage is further based on historical narrative data, whereby prior events relating to a corresponding character affect the delivery of a later passage without explicit description in the later passage.

5. The audio narration system of claim 2, wherein the processor is further configured to, via the text analysis model, generate one or more narration recommendations based on the text classifications and the one or more context parameters.

6. The audio narration system of claim 5, wherein the processor is further configured to, via the audio narration model, generate the audio narration based on the one or more narration recommendations.

7. The audio narration system of claim 1, wherein the processor is further configured to dynamically modify the delivery when a detected emotional intensity of a passage exceeds a predefined threshold without modifying text of the passage.

8. The audio narration system of claim 1, wherein the delivery also reflects auxiliary non-textual inputs in combination with text-derived content comprising the text classifications the and one or more context parameters.

9. A method for an audio narration system, comprising:
receiving text data, wherein the text data comprises a plurality of passages;
determining text classifications for the plurality of passages, wherein each passage of the plurality of passages is classified as one of dialogue, narration, and a meta-narration element;
determining one or more context parameters of the text data, wherein the one or more context parameters are determined for each passage of the plurality of passages and one or more of the context parameters are determined for sequences of passages of the plurality of passages;
generating an audio narration based on the text classifications and the one or more context parameters. wherein the audio narration retains narrative context, character identity, and delivery attributes across passages based on the text classifications and the one or more context parameters; and
outputting the audio narration to a user device.

10. The method of claim 9, wherein determining the text classifications and the one or more context parameters comprises deploying a trained text analysis model.

11. The method of claim 10, further comprising generating one or more narration recommendations with the trained text analysis model based on the text classifications and the one or more context parameters.

12. The method of claim 11, wherein generating the audio narration comprises deploying a trained narration model, wherein the trained narration model is configured to ingest the one or more narration recommendations and output the audio narration based on the one or more narration recommendations.

13. The method of claim 9, wherein generating the audio narration comprises deploying a trained narration model, wherein the trained narration model is configured to ingest the text classifications and the one or more context parameters and output the audio narration based on the text classifications and the one or more context parameters.

14. The method of claim 9, further comprising assigning one or more voices to the plurality of passages based on the text classifications and the one or more context parameters, wherein the one or more context parameters comprise at least speaker identity for each of the plurality of passages.

15. The method of claim 9, wherein the one or more context parameters comprise one or more of sentence structure, narrative intent, character cues, speaker identity, emotional cues, situational context, explicitly stated emotions, story flow/progression, and scene setting.

16. An audio narration system, comprising:
a local processing component disposed at an edge device, the edge device comprising non-transitory memory storing a text analysis model and instructions that when executed cause a first processor of the edge device to:
receive text data from a user input device communicatively coupled to the edge device; and
process the text data with the text analysis model determine, locally at the edge device, text classifications for each passage of the text data and one or more context parameters for one or more of each passage of the text data and sequences of passages of the text data; and
a text narration model stored remotely in a server, wherein the text narration model is configured to ingest the text data, the text classifications for each passage of the text data, and the one or more context parameters; and
generate an audio narration of the text data based on the text classifications for each passage of the text data and the one or more context parameters; and
transmit the audio narration to the edge device for output via the user input device.

17. The audio narration system of claim 16, wherein the text narration model is configured to adapt narration parameters for future narration outputs based on aggregated listener engagement metrics.

18. The audio narration system of claim 16, wherein the text narration model is configured to access a voice database via the server to obtain one or more voices and assign a voice to each character profile identified in the text classifications and the one or more context parameters.

19. The audio narration system of claim 18, wherein the text narration model is configured to reassign a voice to a character profile based on one or more of performance metrics and engagement metrics for the audio narration.

20. The audio narration system of claim 16, wherein, when generating the audio narration, the text narration model defines character performance states based on the text classifications, wherein the character performance states persist across non-contiguous passages and evolve dynamically based on the one or more context parameters.
